(19) United States
(12) Patent Application Publication
(10) Pub. No.: US 2004/0176494 A1
(43) Pub. Date: Sep. 9, 2004

(54) Preparation of flame retarded polyisocyanurate foams

(76) Inventors: Elbert F. Feske, Denham Springs, LA (US); William R. Brown, Baton Rouge, LA (US); Susan D. Landry, Baton Rouge, LA (US); Arthur G. Mack, Prairieville, LA (US)

Correspondence Address: EDGAR SPIELMAN, ALBEMARLE CORPORATION, 451 FLORIDA BLVD., BATON ROUGE, LA, 70801, US

(21) Appl. No.: 10/379,849

(22) Filed: Mar. 5, 2003

(51) Int. Cl. C08J 9/00; C08G 18/00

(52) U.S. Cl. 521/161; 521/168; 521/170

(57) ABSTRACT

Polyisocyanurate foams are produced by mixing at least one organic isocyanate and at least one polyol in the presence of at least one aliphatic or cycloaliphatic C₄-C₇ hydrocarbon having a boiling point of 70° C. or less at 760 millimeters pressure, at least one trimerization catalyst, at least one alkylene glycol ester of tetrabromophthalic anhydride, and at least one phosphorus ester selected from (i) tri(chloroalkyl)phosphate in which each alkyl group has 2 or 3 carbon atoms, (ii) dialkyl alkanephosphonates in which each alkyl group has 1 or 2 carbon atoms and in which the alkane group has 1 or 2 carbon atoms, and (iii) triethylphosphate, and wherein the organic isocyanate and polyol components are proportioned to form a polyisocyanurate having an isocyanate index in the range of about 240 to about 280.

### TECHNICAL FIELD

This invention relates to improvements in producing flame retarded polyisocyanurate foams, and to the foams obtained.

### BACKGROUND

One important field of application for flame retarded polyisocyanurate foams is in the manufacture of roof insulating foam in large high throughput continuous laminators. Special difficulties associated with producing such polyisocyanurate foams is the need for rapidly producing foams having highly effective flame retardancy and to overcome the increased flammability of the foams when produced using environmentally-friendly hydrocarbon blowing agents. To compensate for the increased flammability due to use of hydrocarbon blowing agents, producers have found it necessary to operate with foams having a higher than desired isocyanate index, e.g., over 300, so that qualification tests can be passed. As is known in the art, the isocyanate index is the equivalent NCO/OH ratio, and although the actual ratio is 3, those in the art often speak of isocyanate indices in terms of multiples of 100 whereby an actual ratio of 3 is referred to as an isocyanate index of 300. The operation with foams of such higher than desired isocyanate indices means that the foams are more difficult and more expensive to prepare than if the isocyanate index were at a lower level.

Thus a need exists for a way of effectively flame retarding polyisocyanurate foams formed using a hydrocarbon blowing agent, especially if such foams could be produced at lower isocyanate indices, such as 280 or below. This invention is deemed to fulfill this need.

### BRIEF SUMMARY OF THE INVENTION

This invention provides, inter alia, a method of producing a flame retardant polyisocyanurate foam, which method comprises mixing at least one organic isocyanate and at least one polyol in the presence of at least one aliphatic or cycloaliphatic C₄-C₇ hydrocarbon having a boiling point of 70° C. or less at 760 millimeters pressure, at least one trimerization catalyst, at least one alkylene glycol ester of tetrabromophthalic anhydride, and at least one phosphorus ester selected from (i) tri(chloroalkyl)phosphates in which each alkyl group has 2 or 3 carbon atoms, (ii) dialkyl alkanephosphonates in which each alkyl group has 1 or 2 carbon atoms and in which the alkane group has 1 or 2 carbon atoms, and (iii) triethylphosphate, and wherein the organic isocyanate and polyol components are proportioned to form a polyisocyanurate having an isocyanate index in the range of about 240 to about 280. Polyisocyanurate foams with an isocyanate index within this range produced from such components constitute another aspect of this invention.

Other features and embodiments of this invention will be still further apparent from the ensuing description and appended claims.

### FURTHER DETAILED DESCRIPTION OF THE INVENTION

As used herein, the term “polyisocyanurate” refers to polymers resulting from the reaction of polyols and of isocyanates which contain in addition to urethane functional groups, other types of functional groups, in particular triisocyanuric rings formed by trimerization of the isocyanates. Such polymers are also sometimes referred to in the art as modified polyurethanes.

Organic Isocyanate

Various organic isocyanates can be used in the process of this invention as starting materials. The isocyanates may be any of the known aliphatic, alicyclic and aromatic types, as well as mixtures of at least two of these types, and the organic isocyanates may be used singly or two or more of any them can be combined, whether of the same or different types. Thus isocyanates conventionally used in the production of polyurethanes and polyisocyanurates can be used. Non-limiting examples of suitable isocyanates for use in this invention include aromatic diisocyanates such as 2,4-tolylene diisocyanate, 2,6-tolylene diisocyanate, crude tolylene diisocyanate, diphenylmethane diisocyanate, and crude diphenylmethane diisocyanate; aromatic triisocyanates such as 4,4′,4″-triphenylmethane triisocyanate, and 2,2′,6-tolylene triisocyanate; aromatic tetraisocyanates such as 4,4′-dimethyldiphenylmethane-2,2′,5,5′-tetraisocyanate; aliphatic isocyanates such as hexamethylene-1,6-diisocyanate; alicyclic isocyanates such as hydrogenated diphenylmethane diisocyanate; and other diisocyanates such as m-phenylene diisocyanate, naphthylene-1,5-diisocyanate, 1-methoxyphenyl-2,4-diisocyanate, 4,4′-biphenyl diisocyanate, 3,3′-dimethoxy-4,4′-biphenyl diisocyanate, and 3,3′-dimethyldiphenylmethane-4,4′-diisocyanate. Among the various isocyanates which can be used, preferred are 2,4-tolylene dilsocyanate, 2,6-tolylene diisocyanate, crude tolylene diisocyanate, diphenylmethane diisocyanate, crude diphenylmethane diisocyanate, hexamethylene-1,6-diisocyanate, and hydrogenated diphenylmethane diisocyanate.

Preferred organic isocyanates for use in this invention are crude polymeric diphenylmethane diisocyanate products. These isocyanates are commonly referred to as MDI-type isocyanates, and are commercially available with functionalities of from 2.0 to 3.2.

The organic isocyanate and polyol components are proportioned to form a polyisocyanurate having an isocyanate index in the range of about 240 to about 280, and preferably they are proportioned such that the isocyanate index of the polyisocyanurate is in the range of about 250 to about 275.

Polyol

Polyols used in the practice of this invention can be any compound containing at least two functional groups which react with isocyanates to prepare a polyisocyanurate. These functional groups contain at least one active hydrogen atom, such as defined by the Zerewittinoff reaction. The active hydrogen atom is generally a hydrogen atom bonded to an oxygen, nitrogen or sulfur atom, and preferably is the hydrogen atom of a hydroxyl group.

Among suitable polyols are aliphatic, saccharide, or aromatic compounds having two or more hydroxyl groups in the molecule, and mixtures thereof, such as polyether polyols, polyester polyols, and castor oil. Those polyols that are conventionally used in the production of polyurethanes can also be used similarly. The polyols used may be of either lower molecular weight or high molecular weight. Specific examples thereof include, as polyether polyols, those compounds having structures of active hydrogen-containing compounds such as polyhydric alcohols, polyhydric phenols, amines, or polycarboxylic acids to which alkylene oxides are added. As the polyhydric alcohols, there can be cited, for example, dihydric alcohols such as ethylene glycol, propylene glycol, 1,4-butanediol, 1,6-hexanediol, diethylene glycol, and neopentyl glycol; trihydric or higher polyhydric alcohols such as pentaerythritol, and sucrose. As polyhydric phenols, there can be cited, for example, polyhydric phenols such as pyrogallol, and hydroquinone; bisphenols such as bisphenol A; condensates of phenol and formaldehyde; and other similar materials. As amines, there can be cited, for example, ammonia, alkanolamines such as mono-, di- and triethanolamines, isopropanolamine, and aminoethylethanolamine; C₁-C₂₂ alkylamines, C₂-C₆ alkylenediamines, polyalkylenepolyamines, aromatic amines such as aniline, phenylenediamine, diaminotoluene, xylenediamine, methylenedianiline, and diphenyletherdiamine, alicyclic amines such as isophoronediamine, and cyclohexylenediamine, heterocyclic amines, and similar substances. As the polycarboxylic acids, there can be cited, for example, aliphatic polycarboxylic acids such as succinic acid, adipic acid, sebacic acid, maleic acid, and dimer acid, aromatic polycarboxylic acids such as phthalic acid, terephthalic acid, trimellitic acid, and pyromellitic acid, etc. These active hydrogen-containing compounds may also be used as a mixture of two or more of them. As the alkylene oxides to be added to the active hydrogen-containing compounds, there can be cited, for example, ethylene oxide, propylene oxide, butylene oxide, tetrahydrofuran, etc. These alkylene oxides may be used singly or two or more of them may be used in combination. In the latter case, there may be blocked adducts or randomly added products. As polyester polyols, there can be cited, for example, condensed polyester polyols obtained by the reaction between polyhydric alcohols (the aforementioned alcohols, trimethylolpropane, glycerol, etc.) and carboxylic acids (the aforementioned polycarboxylic acids, etc.), polyester polyols obtained by ring opening polymerization lactone, scrap PET to which ethylene oxide adduct of nonylphenol is added, and the like. Among them, aliphatic, aromatic, aliphatic or aromatic amine, pentaerythritol, or sucrose based polyether polyols; aromatic or aliphatic carboxylic acid polyester polyols; lactone polyester polyols; etc., are preferred. The aforementioned polyols may be used singly or two or more of them may be used in combination.

The polyols may have a hydroxyl number within the range of generally 20 to 600 mg KOH/g, preferably 25 to 500 mg KOH/g, and more preferably 150 to 400 mg KOH/g.

Amounts of the polyols used can vary, but in general will fall in the range of about 10 to about 50 wt %, and preferably in the range of about 20 to about 30 wt %, based on the total weight of polyol, isocyanate, flame retardant alkylene glycol ester of tetrabromophthalic anhydride, and flame retardant phosphorus ester components being used to form the polyisocyanurate.

Blowing Agent

The blowing agent used pursuant to this invention is or at least includes an aliphatic or cycloaliphatic C₄ -C₇ hydrocarbon. This material has a boiling point of 70° C. or less at 1 atmosphere, preferably 50° C. or less. The hydrocarbon is has a sufficiently low boiling point to be gaseous at the exothermic temperatures caused by the reaction between the isocyanate and polyols, so as to foam the resulting polyurethane matrix. The hydrocarbon blowing agents consist exclusively of carbon and hydrogen; therefore, they are non-halogenated by definition. Examples of the C₄-C₇ hydrocarbon blowing agents include linear or branched alkanes, e.g., butane, isobutane, 2,3-dimethylbutane, n- and isopentane and technical-grade pentane mixtures, n- and isohexanes, and n- and isoheptane. Specific examples of alkenes are 1-pentene, 2-methylbutene, 3-methylbutene;, and 1-hexene, and of cycloalkanes are cyclobutane, preferably cyclopentane, cyclohexane or mixtures thereof. Preferably, n-pentane or isopentane, or mixtures thereof are employed.

Other blowing agents can be used in combination with the one or more C₄-C₇ hydrocarbon blowing agents; these may be divided into the chemically active blowing agents which chemically react with the isocyanate or with other formulation ingredients to release a gas for foaming, and the physically active blowing agents which are gaseous at the exotherm foaming temperatures or less without the necessity for chemically reacting with the foam ingredients to provide a blowing gas. Included within the meaning of physically active blowing agents are those gases which are thermally unstable and decompose at elevated temperatures. Examples of chemically active blowing agents are preferably those which react with the isocyanate to liberate a gas, such as CO₂. Suitable chemically active blowing agents include, but are not limited to, water, mono- and polycarboxylic acids having a molecular weight of from 46 to 300, salts of these acids, and tertiary alcohols.

Water may be used as a co-blowing agent with the hydrocarbon blowing agent. Water reacts with the organic isocyanate to liberate CO₂ gas which is the actual blowing agent. However, since water consumes isocyanate groups, an equivalent molar excess of isocyanate should be provided to make up for the consumed isocyanates.

The organic carboxylic acids used as the chemically active blowing agents are advantageously aliphatic mono- and polycarboxylic acids, e.g., dicarboxylic acids. However, other organic mono- and polycarboxylic acids are also suitable. The organic carboxylic acids may, if desired, also contain substituents which are inert under the reaction conditions of the polyisocyanate addition or are reactive with isocyanate, and/or may contain olefinically unsaturated groups. Specific examples of chemically inert substituents are halogen atoms, such as fluorine and/or chlorine, and alkyl groups, e.g., methyl or ethyl. The substituted organic carboxylic acids preferably contain at least one further group which is reactive toward isocyanates, e.g., a mercapto group, a primary and/or secondary amino group, or a primary and/or secondary hydroxyl group.

Suitable carboxylic acids are thus substituted or unsubstituted monocarboxylic acids, e.g., formic acid, acetic acid, propionic acid, 2-chloropropionic acid, 3-chloropropionic acid, 2,2-dichloropropionic acid, hexanoic acid, 2-ethylhexanoic acid, cyclohexanecarboxylic acid, dodecanoic acid, palmitic acid, stearic acid, oleic acid, 3-mercapto-propionic acid, glycolic acid, 3-hydroxypropionic acid, lactic acid, ricinoleic acid, 2-aminopropionic acid, benzoic acid, 4-methylbenzoic acid, salicylic acid and anthranilic acid, and unsubstituted or substituted polycarboxylic acids, preferably dicarboxylic acids, e.g., oxalic acid, malonic acid, succinic acid, fumaric acid, maleic acid, glutaric acid, adipic acid, sebacic acid, dodecanedioic acid, tartaric acid, phthalic acid, isophthalic acid and citric acid. Preferable acids are formic acid, propionic acid, acetic acid, and 2-ethylhexanoic acid, particularly formic acid.

The salts of carboxylic acids are usually formed using tertiary amines, e.g., triethylamine, dimethylbenzylamine, diethylbenzylamine, triethylenediamine, or hydrazine. Tertiary amine salts of formic acid may be employed as chemically active blowing agents which will react with the organic isocyanate. The salts may be added as such or formed in situ by reaction between any tertiary amine (catalyst or polyol) and formic acid contained in the polyester polyol resin blend.

Combinations of any of the above chemically active blowing agents may be employed, such as formic acid, salts of formic acid, and/or water.

Physically active blowing agents suitable for use in combination with the hydrocarbon blowing agents are those which boil at the foaming exotherm temperature or less, preferably at 50° C. or less at 1 atmosphere. The most preferred physically active blowing agents are those which have an ozone depletion potential of 0.05 or less. Examples of other physically active blowing agents that can be used in addition to hydrocarbons, are dialkyl ethers, cycloalkylene ethers and ketones; hydrofluorocarbons (HFCs); perfluorinated hydrocarbons; fluorinated ethers; and to the extent, if any, permitted by applicable laws or regulations, hydrochlorofluorocarbons (HCFCs).

Illustrative examples of suitable hydrofluorocarbons, perfluorinated hydrocarbons, and fluorinated ethers which can be used along with the hydrocarbon blowing agent include difluoromethane (HFC-32); 1,1,1,2-tetrafluoroethane (HFC-134a); 1,1,2,2-tetrafluoroethane (HFC-134); 1,1-difluoroethane (HFC-152a); 1,2-difluoroethane (HFC-152), trifluoromethane; heptafluoropropane; 1,1,1-trifluoroethane; 1,1,2-trifluoroethane; 1,1,1,2,2-pentafluoropropane; 1,1,1,3,3-pentafluoropropane; 1,1,1,3-tetrafluoropropane; 1,1,2,3,3-pentafluoropropane; 1,1,1,3,3-pentafluoro-n-butane; hexafluorocyclopropane (C-216); octafluorocyclobutane (C-318); perfluorotetrahydrofuran; perfluoroalkyl tetrahydrofurans; perfluorofuran; perfluoropropane, perfluorobutane, perfluorocyclobutane, perfluoropentane, perfluorocyclopentane, perfluorohexane, perfluorocyclohexane, perfluoroheptane, and perfluorooctane; perfluorodiethyl ether; perfluorodipropyl ether; and perfluoroethyl propyl ether.

Decomposition type physically active blowing agents which release a gas through thermal decomposition can also be used. These include pecan flour, amine/carbon dioxide complexes, and alkyl alkanoate compounds, especially methyl and ethyl formates.

The total and relative amounts of blowing agents will depend upon the desired foam density, the type of hydrocarbon blowing agent, and the amount and type of additional blowing agents employed. Polyisocyanate foam densities typical for rigid insulation applications range from free rise densities of about 1.4 to about 2.3 pounds per ft³ (pcf), preferably from about 1.6 to about 1.9 pcf, and overall molded densities of about 1.7 to about 1.9 pcf. The amount by weight of all blowing agents in the resin blend is generally about 15 php to about 30 php, preferably about 23 php to about 26 php, where php means parts per hundred parts of all polyols. Based on the weight of all the foaming ingredients (i.e., the resin blend and the isocyanate), the total amount of blowing agent is generally in the range of about 4 wt % to about 10 wt %. The amount of hydrocarbon blowing agent, based on the weight of all the foaming ingredients, may also be in the range of about 4 wt % to about 8 wt %, and preferably in the range of about 5 wt % to about 7 wt %.

Water is typically found in minor quantities in the polyols as a byproduct and may be sufficient to provide the desired blowing from a chemically active substance. Optionally, however, water may be additionally introduced into the polyol resin blend in amounts from 0.05 to 5 php, preferably from 0.25 to 1.0 php. The physically active blowing agents, if employed, make up the remainder of the blowing agent for a total of from 5 php to 35 php based on the total resin blend, or 3 wt % to 15 wt % based on the weight of all the foaming ingredients.

Trimerization Catalyst

Any of a wide variety of known trimerization catalysts can be used in forming the polyisocyanurates pursuant to this invention. Non-limiting examples of suitable trimerization catalysts are the following:

A) Tertiary amines, such as triethylamine, N,N′,N″-tris (dimethylaminopropyl)hexahydrotriazine, 2,4,6-tris (dimethylaminomethyl)phenol,tetramethylethylenediamine, triethylenediamine, a Mannich base obtained by reacting phenol or phenol having alkyl substituent and dimethylamine with formaldehyde, cycloamidines, and the like.

B) Tertiary amines together with a cocatalyst, the cocatalyst being ethyl alcohol, mono N-substituted carbamic acid esters, water, aliphatic aldehydes, tertiary imines, benzoyl peroxide, ethylene carbonate, alpha-diketones (for example, diacetyl), various epoxy compounds, and the like.

C) Tertiary phosphines, such as for example, triethylphosphine, tributylphosphine, triphenylphosphine, cyclohexyldiphenylphosphine, and analogous tertiary organophosphines.

D) Alkali metal imide salts, for example, lithium phthalimide, potassium phthalimide, sodium succinimide and the like.

E) Organic onium compounds, for example, quaternary hydroxides containing nitrogen, phosphorus, sulfur, arsenic or antimony, such as tetraethylammonium hydroxide, benzyltriethylammonium hydroxide, tetraethylphosphonium hydroxide, trimethylphosphonium hydroxide, and similar compounds.

F) Ethyleneimines, for example, N-butylethyleneimine, 2-hydroxyethylethyleneimine, and the like,

G) Metal salts of carboxylic acids, for example, potassium acetate, potassium octanoate, potassium 2-ethylcaproate, lead 2-ethylcaproate, sodium benzoate, potassium naphthenate, stannous octanoate, and the like.

H) Basic inorganic compounds, for example, potassium carbonate, potassium hydroxide, barium oxide, potassium hydroxide, sodium hydroxide, and the like.

I) Alcoholates and phenolates, for example, sodium methoxide, potassium phenolate, sodium trichlorophenolate, and the like.

J) Titanium and antimony compounds, for example, tetrabutyltitanate, tri-n-butylantimony oxide, and the like.

K) Friedel-Crafts catalysts, for example, ZnCl₂, SnCl₄, FeCl₃, SbCl₅, AlCl₃, BF₃, and the like.

L) Alkali metal complexes, for example, complexes of salicylaldehyde, acetylacetone, o-hydroxyacetophenone, quinizarin, and like complexing agents with alkali metals; alkali metal complexes of tetravalent boron compounds, for example, [(R¹O)₂BOR²]^{⊖} M^{⊕}, wherein M is an alkali metal, and R¹ and R² are monovalent organic groups; and similar substances.

Among the suitable trimerization catalysts, it is preferable to use one or more compounds belonging either to type A) above or type G) above, or to use a compound of type A) together with a compound of type G). The amount of trimerizing catalyst used is typically in the range of about 1 to about 10% by weight based on the weight of the organic polyisocyanate being produced.

Flame Retardants

As noted above the present invention utilizes particular combinations of flame retardants, namely one or more alkylene glycol esters of tetrabromophthalic anhydride, and one or more tri(chloroalkyl)phosphates in which each alkyl group has 2 or 3 carbon atoms, one or more dialkylalkanephosphonates.

The alkylene glycol(s) used in forming the esters of tetrabromophthalic anhydride can be an alkylene glycol in which both hydroxyl groups can be attached to terminal or internal carbon atoms, or in which one hydroxyl group is attached to a terminal carbon atom and the other hydroxyl group is attached to an internal carbon atom. Alternatively, the glycol used in forming the esters of tetrabromophthalic anhydride can be a dialkylene glycol. In either case the glycol portion will typically contain in the range of 2 to about 6 carbon atoms and preferably in the range of 2 to about 4 carbon atoms. Mixtures of the foregoing esters can be used, such as mixed esters of tetrabromophthalic anhydride with ethylene glycol and diethylene glycol. Other such mixtures of the foregoing esters that can be used are mixed esters of tetrabromophthalic anhydride with diethylene glycol and propylene glycol; a particularly preferred mixed ester of this type is available commercially from Albemarle Corporation as Saytex® RB-79 flame retardant. Also preferred is Saytex® RB-7980 flame retardant which is a blend of mixed esters of 3,4,5,6-tetrabromophthalic anhydride with diethylene glycol and propylene glycol and tri(chloropropyl)phosphate, this being another commercial product of Albemarle Corporation.

The chloroalkylphosphate esters used pursuant to this invention are (i) tri(2-chloroethyl)phosphate and (ii) tri(2-chloropropyl)phosphate, which can be (a) any one of the four isomers of tri(2-chloropropyl)phosphate, namely, tri(2-chloro-n-propyl)phosphate, tri(2-chloroisopropyl)phosphate, di(2-chloro-n-propyl)(2-chloroisopropyl)phosphate, or di(2-chloro-isopropyl)(2-chloro-n-propyl)phosphate, or (b) any combination, of any two, any three, or all four of such isomers, and in any proportions between or amongst the two, the three, or the four such isomers. Thus unless otherwise specified, the term “tri(2-chloropropyl)phosphate” means (a) and (b) as just described. Mixtures of tri(2-chloroethyl)phosphate and tri(2-chloropropyl)phosphate can be used and such mixtures can be in any relative proportions between or amongst themselves ranging from a trace of tri(2-chloroethyl)phosphate along with tri(2-chloropropyl)phosphate, to tri(2-chloroethyl)phosphate along with a trace of tri(2-chloropropyl)phosphate.

The phosphonate esters have two ester groups, and one alkyl group which is directly bonded to the phosphorus atom, this sometimes being referred to as an alkane group to distinguish it from the alkyl groups on the two esterified oxygen atoms of the phosphonate. The alkane and alkyl groups each have, independently, 1 or 2 carbon atoms. These compounds are dimethyl methanephosphonate, dimethyl ethanephosphonate, diethyl methanephosphonate, diethyl ethanephosphonate, (ethyl)(methyl) methanephosphonate, and (ethyl)(methyl) ethanephosphonate, or any mixture of any two or more of these compounds. Such mixtures can have the components in any relative proportions to each other in the mixture.

The other phosphorus ester which can be used pursuant to this invention is triethylphosphate. It is also possible to use mixtures of one or more of the above chloroalkylphosphates with one or more of the above phosphonate esters with or without inclusion of triethylphosphate as well. Likewise it is possible to use mixtures of one or more of the above phosphonate esters with triethylphosphate, or mixtures of one or more of the above chloroalkylphosphates with triethylphosphate. All such mixtures can have the components in any proportions relative to each other.

Most preferred as the phosphorus ester is tri(2-chloropropyl)phosphate, and best results to date have resulted from its use, despite the fact that it has lower percentages of phosphorus and of halogen than tri(chloroethyl)phosphate and also has a higher percentage of carbon in the molecule and thus would be expected to be more flammable than tri(chloroethyl)phosphate.

Still other tertiary organic phosphate esters can be used in combination with the above phosphorus esters. Examples of such other tertiary phosphate esters include, for example, tripropylphosphate, triisopropylphosphate, tributylphosphate, tri(2-bromoethyl)phosphate, tri(2-bromopropyl)phosphate, tri(dichloropropyl)phosphate, and the like.

Typically the weight ratio between (A) the phosphate ester(s) and (B) the alkylene glycol ester(s) of tetrabromophthalic anhydride will be in the range of about 40 parts by weight of (A) and about 60 parts by weight of (B) to about 70 parts by weight of (A) and about 30 parts by weight of (B). Preferred weight ratios of (A):(B) are in the range of about 45:55 to about 55:45. With tri(2-chloropropyl)phosphate and mixed esters of tetrabromophthalic anhydride with diethylene glycol and propylene glycol, the weight ratio of about 55:45 is especially preferred, as such mixtures have been found to give better overall performance than predicted from the results of tests with each of five different phosphorus esters (one of which was tri(2-chloropropyl)phosphate) used with a mixed ester of 3,4,5,6-tetrabromophthalic anhydride with diethylene glycol and propylene glycol (Saytex® RB-79 flame retardant).

The total amount of the flame retardant components used in the polyisocyanurate will typically be in the range of about 1 to about 6 wt %, and preferably in the range of about 2 to about 4 wt %, based on the total weight of polyol, blowing agent and flame retardant components.

In addition to the organic isocyanate, polyol, hydrocarbon blowing agent, trimerization catalyst, and flame retardants referred to above, the polyisocyanurate formulations of this invention can additionally contain various additives commonly used to prepare polyisocyanurate or modified polyurethane foams, such as, for example, water, surfactants, polymerization catalysts, antioxidants, curing agents, fillers, and/or pigments.

Surfactants

Either or both of two types of surfactants can be used, and preferably are used, in the practice of this invention. One type of surfactant can be used for control of cell size in the foam. The other type is an emulsifier type surfactant to minimize separation of phases in the premix used in forming the polymer.

In the practice of this invention, surfactants used for cell-size control are preferably silicone-based surfactants. Surfactants used for emulsion stabilization are preferably silicon-free types of nonionic surfactants, and of these polyoxyalkylene nonionic surfactants are particularly preferred.

The silicone-based surfactants are well known substances, and include organopolysiloxane-polyoxyalkylene copolymers and polyalkenylsiloxanes having polyoxyalkylene side chains. The amounts of such organosilicon surfactants will typically fall in the range of about 0.3 to about 2 wt %, and preferably in the range of about 0.5 to about 1 wt %, based on the total weight of the polyol, blowing agent and flame retardant components.

By the term “nonionic surfactant” as used herein is meant a compound which contains one or more hydrophobic moieties and one or more hydrophilic moieties and which has no moieties which dissociate in aqueous solution or dispersion into cations and anions. While nearly any nonionic surfactant compound can be employed, in general, in the practice of the present invention, it is preferred that the nonionic surfactant be a polyoxyalkylene surfactant which contains an average of from about 4 to about 240 individual oxyalkylene groups per molecule with the oxyalkylene groups typically being selected from the group consisting of oxyethylene and oxypropylene.

Polyoxyalkylene nonionic surfactants may be based on any starting material which bears groups with hydrogen atoms reactive to alkoxylation. This includes hydroxyl, carboxyl, thiol, and primary and secondary amine groups. The surfactants may be based on materials with three or more alkoxylation-active functional groups, as well as the more commonly used mono- and di-functional starting materials. Thus, the product formed from glycerol, reacted with propylene oxide to form three discrete polyoxypropylene blocks, followed by reaction with ethylene oxide to add one polyoxyethylene block to each polyoxypropyleneblock, is a nonionic surfactant (in certain circumstances this nonionic surfactant may also function as a polyol), so long as it has polyoxypropylene blocks of sufficient size to function as the hydrophobic portion of the molecule. The fact that block polymers with more than two polyoxyalkylene chains can function as surfactants is illustrated by the Tetronic® series of commercial surfactant products, described in Polyethers, Part I: Polyalkylene Oxides and Other Polyethers, N. G. Gaylord, ed., Interscience, 1963, pp. 233-7. Useful Tetronic surfactants generally have four polyoxyalkylene chains and exhibit the surface activity typical of materials used as surfactants. It is also notable that propoxylation to an average level of only two propylene oxide units per chain, followed by ethoxylation, is sufficient to create a material which functions as a non-ionic surfactant. The hydrophobic portion of a nonionic surfactant is preferably derived from at least one starting compound which is any of the following:

a) fatty alcohols containing from about 6 to 18 carbon atoms each,

b) fatty amides containing from about 6 to 18 carbon atoms each,

c) fatty amines containing from about 6 to 18 carbon atoms each,

d) fatty acids containing from 6 to 18 carbon atoms each,

e) phenols and/or alkyl phenols wherein the alkyl group contains from about 4 to 16 carbon atoms each,

f) fats and oils containing from 6 to about 60 carbon atoms each, and

g) glycols which may contain one or more ether oxygen atoms, and

h) mixtures thereof.

In making a nonionic surfactant, such a starting compound is sufficiently alkoxylated to provide a desired hydrophilic portion. Depending on the alkoxylation reaction conditions typically used by one of ordinary skill in the art, the starting compound is alkoxylated on average with about 3 to 125 moles of alkylene oxide per mole of starting compound, where the alkoxylation material preferably being selected from the group consisting of ethylene oxide, propylene oxide, and mixtures thereof. Examples include polyoxypropylene glycols containing from 10 to 70 moles of ethylene oxide.

One class of nonionic surfactants employable in the practice of this invention is characterized by the formula:

RO(CH₂CH₂O)ₙH

where R is an alkylphenyl group wherein the alkyl portion in each such group contains about 4 to about 18 carbon atoms, and n is a positive whole number which is sufficient to keep the molecular weight of the product surfactant below about 1500.

The nonionic surfactants employable in the practice of this invention can contain block units of ethylene oxide in combination with block units of propylene oxide or butylene oxide. Thus the hydrophobic part of a molecule may contain recurring butylene oxide or propylene oxide units or mixed units of butylene oxide and propylene oxide. Minor amounts of ethylene oxide may also be present within the blocks of propylene oxide or butylene oxide. Thus, the hydrophobic portion may consist of a polyoxyalkylene block derived from alkylene oxides with at least three carbon atoms, an alkyl, aryl, or alkaryl hydrocarbon group with at least six carbon atoms, as for instance from a fatty alcohol, or a combination of one or more such polyoxyalkylene blocks and one or more such hydrocarbon groups. Preferably, the hydrophilic portion of the nonionic surfactants employed herein is comprised of ethylene oxide units.

One preferred class of nonionic surfactants contains at least one block polyoxypropylene group containing at least about 5 propoxy units and also at least one block polyoxyethylene group containing at least about 5 ethoxy units.

One particularly preferred class of nonionic surfactant is characterized by having:

1) a molecular weight of at least from about 3000 to 6000,

2) at least one block polyoxypropylene group which contains from about 10 to 70 repeating propoxy units,

3) at least one block polyoxyethylene group which contains from about 10 to 100 repeating ethoxy units, and

4) both a hydrophobic moiety and a hydrophilic moiety.

In such a nonionic surfactant as above characterized, the total alkoxylene content should include at least 10 weight percent of ethylene oxide, and preferably the ethylene oxide content ranges from about 20 to 60 weight percent, and most preferably the ethylene oxide content ranges from about 30 to 40 weight percent. Preferably such a nonionic surfactant is end capped with at least one ethylene oxide group.

Typically, the amount of the nonionic surfactant, based on the combined weight of polyol and nonionic surfactant, is generally from about 1-30% by weight, more preferably 4-26% by weight, and most preferably 6-20% by weight. Additionally, the combined amount of the polyol and nonionic surfactant, based on the total weight of polyol, nonionic surfactant and blowing agent is generally from about 65-99% by weight.

Polymerization Catalyst

The polymerization catalyst component or components which can be used may be regarded as a urethanation catalysts as they promote the formation of the —NH—CO—O— urethane bonds in the polyisocyanurate. Tertiary amines and organic tin, iron, mercury, or lead compounds are among suitable polymerization catalysts. A few non-limiting examples of such catalysts include triethylenediamine, dimethylethanolamine, triethylamine, trimethylaminoethylethanolamine, dimethylaminoethylether, N-methyl-morpholine, dibutyltin dilaurate, tin octanoate, lead octanoate, and other similar substances. Amounts used are typically in the range of about 0.01 to about 1 wt % based on the total weight of the polyisocyanurate foam.

### EXAMPLES

The efficacy of the present invention was demonstrated by conducting experimental work described below.

Experimental Design

a) A series of 58 polyisocyanurate polymers were prepared in which the components selected for use were Mondur 489 as the organic isocyanate, Stepan 2352 as the polyol, n-pentane as a blowing agent, a mixed ester of 3,4,5,6-tetrabromophthalic anhydride with diethylene glycol and propylene glycol (SAYTEX® RB-79 flame retardant; Albemarle Corporation), one of five different organic phosphorus esters, namely tri(2-chloropropyl)phosphate, tri(2-chloroethyl)phosphate, dimethyl methanephosphonate, diethyl ethanephosphonate, or triethylphosphate, potassium octanoate and tertiary amine catalysts, alkoxylated methylsiloxane surfactant from Pelron, and a mixture of Poly-G 601-31 from Olin and water (10:1) as an emulsifier for the n-pentane blowing agent which is not soluble in the polyol.

b) The amount of catalyst, blowing agent and surfactant were held constant, while varying the other components. The variables used in these runs were: the amount of isocyanate, the amount of polyol, the total amount of the SAYTEX® RB-79 flame retardant and phosphate ester used, the ratio of the SAYTEX® RB-79 flame retardant to the phosphate ester used, and the phosphate additive used.

c) The ranges of variables within the formulation were: Isocyanate index was varied between 250 and 350, the amount of SAYTEX® RB-79 flame retardant and phosphate ester was varied between 10 and 25 parts per hundred parts of polyol (wt/wt); the ratio between the amount of SAYTEX® RB-79 flame retardant and phosphate ester was varied between 90 wt % RB-79 to 10 wt % phosphate ester and 40 wt % RB-79 to 60 wt % phosphate ester.

d) The data from these runs was processed by a software package called Design Expert, using a mathematical model designed for analyzing multi-variable mixtures in which any of the parts of the mixture can be varied and any of the parts can be held constant. The processed data from the computer identified optimal formulations within the scope of the input data (formulation makeup and results).

e) Two of these optimal formulations were made up and tested in the same manner as in the original series.

The foams in all of these runs were prepared by introducing weighed amounts of the ingredients of the “B” sides premixes, except for a mixture of the catalysts, into a wide-mouth round bottle. Each bottle was capped tightly and rolled until a uniform emulsion was obtained. The “B” side premix was then added to a weighed amount of isocyanate at room temperature and mixed using a 2.5-inch Spyral Turbomixer (bowtie configuration) from Indco at 1200 rpm until uniform. The catalyst blend was injected into the A & B premix while the mixer was running and the resultant mixture was mixed for 5 seconds more. The reacting mass was then poured into a 14-inch×14-inch×10-inch box which had been set into a jig to maintain straight sides. The box and jig top were quickly closed to ensure the upper corners were filled. Vent holes were cut into upper corners of the box to allow air to escape. After a period of five minutes, the box was removed from the jig and allowed to sit overnight at room temperature. The box was then trimmed away and samples were cut from the center of the resultant block of foam. Four 12-inch×12-inch×1.5-inch panels were cut for use in the RB-850 Roof Panel Burn Chamber.

The Roof Panel Burn Apparatus

The Roof Panel Burn Apparatus provides a screening tool with which to predict the outcome of much larger tests. It consists of an insulated 24-inch×24-inch stainless steel outer wall, inside of which resides a ceramic heater that covers the bottom. One inch above the heater is a corrugated steel roofing panel. Three thermocouples are mounted to the top of the steel panel to measure and control the heater. A sample of a foam panel, 24-inch×24-inch, is placed on the corrugated steel panel and a lid is placed on the box in contact with the foam. Although the thickness of the foam can be between 1.5 and 3 inches, in these runs the samples used were 1.5-inches thick. In the lid are 5 thermocouples, one in the center and four toward the corners, that monitor the temperature above the foam during the test. Computer software both controls the heater output and records the measurements from the 8 thermocouples during the test. The center thermocouple on top of the corrugated steel panel is used as the control measurement for the heater. For a detailed description of this apparatus and its use, see commonly-owned copending application Ser. No. 09/982,487, filed Oct. 17, 2001. The apparatus is fabricated from non-combustible materials and is maintained within a vent hood to remove any smoke that is generated during a test operation.

Experimental Test Procedure

Each test in the RB-850 Roof Panel Burn Apparatus was conducted using the following procedure: A pre-weighed foam panel is placed in the chamber and the lid is closed. The test is initiated by the operator through the use of the control computer. Once activated, the heater increases the temperature of the corrugated panel at a predetermined rate until 850° C. is reached. Then the temperature is controlled by the computer, which turns the heater off and on to keep the temperature between 840° C. and 860° C. The test runs for 30 minutes during which, the temperature is monitored at each thermocouple and recorded by the computer site every 30 seconds. The heater is turned off after the 30-minute test period and the remains of the sample are removed. After the weight and dimensional change of the sample are measured, a photograph is taken of the remains for later reference.

The data generated by use of the RB-850 Roof Panel Burn Apparatus were as follows:

A. Overall Effect: The data collected by the computer associated with the apparatus during the test is a series of temperature versus time curves, one for each thermocouple. From the many different parameters drawn from the curves, one termed the “Overall Effect” was selected as the most useful and representative of the results. The plot made by the control thermocouple can be thought of as the Heat Input during the test. The average of the results measured from the thermocouples in the lid can be thought of as the Heat Transferred through the foam during the test. This parameter, Overall Effect, is calculated by subtracting the average of the integrals of curves of the thermocouples in the lid from the integral of the curve of the control thermocouple. In effect, this measures the loss of insulation capability of the foam as it is pyrolyzed in the apparatus during the test. The lower the temperatures of the upper thermocouples the better the foam performed. Therefore, for this parameter, the greater the difference in the integrals of the upper and lower curves, the better the foam performed. Of course, if a foam burns completely through, the curve of the thermocouple closest to the burn-through site will rise abruptly, which will be reflected in a lowering of the Overall Effect. Thus, the higher the resultant number, the better the foam performed.

B. % Weight Loss: This parameter was measured directly by weighing the sample both before and after the test. Percent Weight Loss was calculated by the expression:

$$\frac{{W}_{b} - {W}_{a}}{{W}_{b}} \times 100 = \% \text{Weight Loss}$$

where W_{b} is the weight of the sample before testing, and Wₐ is the weight of the sample after testing.

C. Shrinkage: Each sample is cut to be 24×24 inches so as to tightly fit into the test chamber. By measuring the sample after the test in three different places (across the center and across near each corner) per dimension, a number that represents the shrinkage in two dimensions that occurred during the test can be calculated using the expression:

$$\frac{{24}^{2} - ( {A}_{1} \times {A}_{2} )}{{24}^{2}} or \frac{576 - ( {A}_{1} \times {A}_{2} )}{576} = \text{Shrinkage}$$

where A₁ is the average of the 3 readings taken in one direction across the face of the sample after testing and A₂ is the average of the readings taken in the other direction across the face of the sample after testing. This is a parameter that is better when the number is lower. Since the thickness of each sample becomes very irregular, no attempt was made to characterize the change in thickness during the test.

Table 1 summarizes the compositions of the polyisocyanurates formed and tested. For ease of reference, in Table 1 the ester of 3,4,5,6-tetrabromophthalic anhydride is identified as “RB-79” and tri(2-chloropropyl)phosphate is identified as “TCPP.” Table 2 sets forth the computer predicted optimum compositions and results from the 58 initial tests, and also the actual results obtained when the predicted compositions were made and tested.

TABLE 1

| | Foam A | Foam B |
|---|---|---|
| A Side | | |
| Isocyanate | 58.19 wt % | 56.95 wt % |
| B Side | | |
| Polyol | 24.65 wt % | 26.63 wt % |
| RB-79 | 3.2 wt % | 3.02 wt % |
| TCPP | 3.97 wt % | 3.42 wt % |
| Blowing Agent | 5.95 wt % | 5.95 wt % |
| Surfactant/Emulsifier | 2.14 wt % | 2.14 wt % |
| Catalysts | 1.90 wt % | 1.90 wt % |
| Isocyanate Index | 270 | 250 |

TABLE 2

| Predicted Properties | Mix A | Mix B |
|---|---|---|
| Overall Effect | 34335 | 34439 |
| Weight Loss, % | 47 | 48 |
| Actual Properties | | |
| Overall Effect | 35600 | 35627 |
| Weight Loss, % | 47.08 | 47.86 |

It will be noted that in the particular mixtures used, the actual values for overall effect were actually higher than predicted.

Table 3 summarizes some of the results from the series of 58 runs, each of which involved forming a polyisocyanurate of this invention from the above components.

TABLE 3

| | | | | | | | Overall | | |
|---|---|---|---|---|---|---|---|---|---|
| Run | % Br | P-FR | % P-FR | % P | % Cl | Index | Effect | % Wt Loss | % Shrinkage |
| 19 | 0.41 | TEP | 3.97 | 0.67 | — | 257 | 31250 | 49.33 | 9 |
| 3 | 0.41 | DMMP | 3.97 | 0.99 | — | 257 | 33400 | 53.08 | 3 |
| 47 | 0.41 | TCEP | 0.22 | 0.02 | 0.08 | 272 | 31908 | 56.13 | 2 |
| 7 | 0.41 | TCPP | 2.03 | 0.19 | 0.66 | 264 | 34130 | 48.05 | 1 |
| 55 | 1.25 | DEEP | 0.22 | 0.04 | — | 254 | 33000 | 58.05 | 9 |
| 50 | 0.41 | TCPP | 3.97 | 0.38 | 1.29 | 257 | 31602 | 52.25 | 7 |
| 48 | 0.41 | TCEP | 3.84 | 0.42 | 1.38 | 256 | 32091 | 49.96 | 6 |
| 20 | 2.08 | TEP | 0.22 | 0.04 | — | 237 | 33790 | 50.70 | 6 |
| 1 | 2.08 | DMMP | 0.22 | 0.06 | — | 237 | 31784 | 53.88 | 7 |
| 37 | 2.08 | TCPP | 0.22 | 0.02 | 0.07 | 237 | 32773 | 51.19 | 5 |
| 52 | 2.62 | DEEP | 0.22 | 0.04 | — | 275 | 31905 | 51.99 | 6 |
| 22 | 2.62 | TEP | 2.10 | 0.36 | — | 248 | 32985 | 47.47 | 8 |
| 2 | 1.52 | TCEP | 3.97 | 0.44 | 1.43 | 258 | 33732 | 51.52 | 4 |
| 35 | 2.62 | TCPP | 2.10 | 0.20 | 0.68 | 248 | 33410 | 51.03 | 4 |

Compounds referred to by chemical name or formula anywhere in this document, whether referred to in the singular or plural, are identified as they exist prior to coming into contact with another substance referred to by chemical name or chemical type (e.g., another component, a solvent, or etc.). It matters not what preliminary chemical changes, if any, take place in the resulting mixture or solution, as such changes are the natural result of bringing the specified substances together under the conditions called for pursuant to this disclosure. Also, even though the claims may refer to substances in the present tense (e.g., “comprises,” “is,” etc.), the reference is to the substance as it exists at the time just before it is first contacted, blended or mixed with one or more other substances in accordance with the present disclosure.

All documents referred to herein are incorporated herein in toto as if fully set forth in this document.

This invention is susceptible to considerable variation within the spirit and scope of the appended claims. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

That which is claimed is:

1. A method of preparing a polyisocyanurate foam, which method comprises mixing at least one organic isocyanate and at least one polyol in the presence of at least one aliphatic or cycloaliphatic C₄-C₇ hydrocarbon having a boiling point of 70° C. or less at 760 millimeters pressure, at least one trimerization catalyst, at least one alkylene glycol ester of tetrabromophthalic anhydride, and at least one phosphorus ester selected from (i) tri(chloroalkyl)phosphate in which each alkyl group has 2 or 3 carbon atoms, (ii) dialkyl alkanephosphonates in which each alkyl group has 1 or 2 carbon atoms and in which the alkane group has 1 or 2 carbon atoms, and (iii) triethylphosphate, and wherein the organic isocyanate and polyol components are proportioned to form a polyisocyanurate having an isocyanate index in the range of about 240 to about 280.

2. A method as in claim 1 wherein said at least one aliphatic or cycloaliphatic C₄-C₇ hydrocarbon is n-pentane.

3. A method as in claim 1 wherein said at least one alkylene glycol ester is a mixed ester of tetrabromophthalic anhydride with diethylene glycol and propylene glycol.

4. A method as in claim 1 wherein said at least one alkylene glycol ester is a mixed ester of tetrabromophthalic anhydride with ethylene glycol and diethylene glycol.

5. A method as in claim 1 wherein said phosphorus ester is one or more tri(2-chloropropyl)phosphate isomers.

6. A method as in claim 1 wherein said at least one alkylene glycol ester is a mixed ester of tetrabromophthalic anhydride with diethylene glycol and propylene glycol, and wherein said phosphorus ester is one or more tri(2-chloropropyl)phosphate isomers.

7. A method as in claim 6 wherein the one or more tri(2-chloropropyl)phosphate isomers and the mixed ester of tetrabromophthalic anhydride with diethylene glycol and propylene glycol are present in a weight ratio of about 55 parts by weight of the one or more phosphate isomers and about 45 parts by weight of the mixed ester.

8. A method as in any of claims 1-7 wherein said at least one aliphatic or cycloaliphatic C₄-C₇ hydrocarbon is n-pentane.

9. A polyisocyanurate foam having an isocyanate index in the range of about 240 to about 280 formed from at least one isocyanate and at least one polyol in the presence of at least one aliphatic or cycloaliphatic C₄-C₇ hydrocarbon having a boiling point of 70° C. or less at 760 millimeters pressure, at least one trimerization catalyst, at least one alkylene glycol ester of tetrabromophthalic anhydride, and at least one phosphorus ester selected from (i) tri(chloroalkyl)phosphate in which each alkyl group has 2 or 3 carbon atoms, (ii) dialkyl alkanephosphonates in which each alkyl group has 1 or 2 carbon atoms and in which the alkane group has 1 or 2 carbon atoms, and (iii) triethylphosphate.

10. A foam as in claim 9 wherein said at least one alkylene glycol ester is a mixed ester of tetrabromophthalic anhydride with diethylene glycol and propylene glycol.

11. A foam as in claim 9 wherein said phosphorus ester is one or more tri(2-chloropropyl)phosphate isomers.

12. A foam as in claim 9 wherein said at least one alkylene glycol ester is a mixed ester of tetrabromophthalic anhydride with ethylene glycol and propylene glycol.

13. A foam as in claim 9 wherein said at least one alkylene glycol ester is a mixed ester of tetrabromophthalic anhydride with diethylene glycol and propylene glycol, and wherein said phosphorus ester is one or more tri(2-chloropropyl)phosphate isomers.

14. A foam as in claim 13 wherein the one or more tri(2-chloropropyl)phosphate isomers and the mixed ester of tetrabromophthalic anhydride with diethylene glycol and propylene glycol are present in a weight ratio of about 55 parts by weight of the one or more phosphate isomers and about 45 parts by weight of the mixed ester.

15. A foam as in any of claims 9-13 wherein said at least one aliphatic or cycloaliphatic C₄-C₇ hydrocarbon is n-pentane.

16. A foam as in any of claims 9-13 formed with an isocyanate index in the range of about 250 to about 275.
